(19) United States
(12) Patent Application Publication
(10) Pub. No.: US 2026/0098560 A1
(43) Pub. Date: Apr. 9, 2026

(54) Two-Piece Sealing Plug for Blind Hold, One-Sided Installation

(71) Applicant: Avdel UK Limited, Woolston (GB)

(72) Inventor: Carl P. HERSANT, Bengeo (GB)

(73) Assignee: Avdel UK Limited, Woolston (GB)

(21) Appl. No.: 19/348,707

(22) Filed: Oct. 2, 2025

Related U.S. Application Data
(60) Provisional application No. 63/703,259, filed on Oct. 4, 2024.

(51) Int. Cl. F16B 19/00

(52) U.S. Cl. CPC F16B 19/008

(57) ABSTRACT

A plug for a blind hole, one-sided installation, includes a stem and a sleeve. The stem extends along a longitudinal axis. The stem includes a stem body and a stem head. The stem body defines a first groove. The stem head includes a radial outer surface that is tapered outward in a direction along the longitudinal axis extending away from the stem body. The sleeve is configured to surround the stem and to deform radially inward during installation of the seal plug such that a portion of the sleeve is in the first groove when the seal plug is in an installed state.

### CROSS-REFERENCE TO RELATED APPLICATION

This application claims priority to U.S. Provisional Patent Application No. 63/703,259, filed Oct. 4, 2024, the disclosure of which is incorporated herein by reference.

### FIELD

The present disclosure relates to a two-piece sealing plug for blind hole, one-sided installation.

### BACKGROUND

This section provides background information related to the present disclosure which is not necessarily prior art.

Two-piece sealing plugs can be installed rapidly into blind holes, helping to eliminate the need to tap threads in various applications. Two-piece sealing plugs often include a stem and a sleeve that surrounds a portion of the stem. Pulling of the stem, for example, using a rivet placing tool may expand the sleeve to securely seal blind holes having a normal drilled surface.

### SUMMARY

This section provides a general summary of the disclosure, and is not a comprehensive disclosure of its full scope or all of its features.

At least one example embodiment relates to a plug configured to be installed in a blind hole from one side thereof.

In at least one example embodiment, the plug includes a stem and a sleeve. The stem extends along a longitudinal axis. The stem includes a stem body and a stem head. The stem body defines a first groove. The stem head includes a radial outer surface that is tapered outward in a direction along the longitudinal axis extending away from the stem body. The sleeve is configured to surround the stem and to deform radially inward during installation of the plug such that a portion of the sleeve is in the first groove when the plug is in an installed state.

In at least one example embodiment, the stem head includes a first portion defining a first angle with respect to the longitudinal axis. The first angle is acute.

In at least one example embodiment, the stem head includes a first portion and a second portion. The second portion defines a second angle with respect to the longitudinal axis. The second angle is acute.

In at least one example embodiment, the first angle ranges from 65° to 69°. The second angle ranges from 5° to 6°.

In at least one example embodiment, the first portion defines a first dimension parallel to the longitudinal axis. The second portion defines a second dimension parallel to the longitudinal axis. A ratio of the second dimension to the first dimension is greater than or equal to about 5.

In at least one example embodiment, the first groove is an annular groove.

In at least one example embodiment, the first groove is directly adjacent to the stem head.

In at least one example embodiment, the sleeve includes a first annular inner surface, a second annular inner surface, and a step surface. The first annular inner surface defines a first bore having a first bore diameter. The second annular inner surface defines a second bore having a second bore diameter larger than the first bore diameter. The step surface is between the first annular inner surface and the second annular inner surface. The step surface is configured to engage the stem head during installation of the plug.

In at least one example embodiment, the step surface defines a third angle with respect to the longitudinal axis. The third angle is acute.

In at least one example embodiment, the third angle ranges from 81° to 85°.

In at least one example embodiment, a ratio of the second bore diameter to the first bore diameter is greater than or equal to 1.2.

In at least one example embodiment, the first annular inner surface and the second annular inner surface are parallel to the longitudinal axis.

In at least one example embodiment, the stem body includes a main portion and a textured portion. The main portion defines the first groove. The textured portion includes knurling, splines, or both knurling and splines.

In at least one example embodiment, a largest diameter of the textured portion is greater than a diameter of the main portion.

In at least one example embodiment, the stem body defines a second groove. The stem body is configured to break at the second groove in response to an application of a predetermined tensile force to the stem parallel to the longitudinal axis.

In at least one example embodiment, the first groove is disposed between the second groove and the stem head along the longitudinal axis.

In at least one example embodiment, the second groove is an annular groove.

In at least one example embodiment, the first groove defines a first transverse dimension. The second groove defines a second transverse dimension. The second transverse dimension is less than the first transverse dimension.

In at least one example embodiment, the plug is an all-aluminum plug. The stem and the sleeve each include an aluminum alloy. The stem has a first hardness that is greater than a second hardness of the sleeve. The sleeve has a first ductility that is greater than a second ductility of the stem.

In at least one example embodiment, at least one of the stem and the sleeve includes aluminum grades 6061, 3103, 7075, or any combination thereof.

In at least one example embodiment, the portion of the sleeve is configured to engage a surface of the first groove to form a fluid-tight seal in the installed state.

In at least one example embodiment, the sleeve is configured to engage a surface of the blind hole to form a fluid-tight seal in the installed state.

At least one example embodiment relates to a plug configured to be installed in a blind hole from one side thereof.

In at least one example embodiment, the plug includes a stem and a sleeve. The stem extends along a longitudinal axis. The stem includes a stem body and a stem head. The stem body defines a first annular groove. The stem head includes a first portion and a second portion. The first portion defines a first angle with respect the longitudinal axis. The first angle is acute. The second portion defines a second angle with respect to the longitudinal axis. The second angle is smaller than the first angle. The sleeve is configured to deform during installation of the plug such that a portion of the sleeve is in the first annular groove when the plug is in an installed state. The sleeve includes a first annular inner surface, a second annular inner surface, and a step surface. The first annular inner surface defines a first bore having a first bore diameter. The second annular inner surface defines a second bore having a second bore diameter. The second bore diameter is larger than the first bore diameter. The step surface is between the first annular inner surface and the second annular inner surface. The step surface is configured to engage the stem head during installation of the plug. The step surface defines a third angle with respect to the longitudinal axis. The third angle being acute.

At least one example embodiment relates to a plug configured to be installed in a blind hole from one side thereof.

In at least one example embodiment, the plug includes a sleeve and a stem. The sleeve defines an interior region. The stem includes a body and a head. In a pre-installed state, the body engages the sleeve to retain the sleeve on the stem. During installation, the stem is configured to translate within the interior region of the sleeve such that the head engages the sleeve to deform a first portion of the sleeve radially outwardly to engage a surface of the blind hole, and to deform a second portion of the sleeve radially inwardly to engage the body. In an installed state, the second portion of the sleeve is at least partially in a receptacle of the body to form an interlock between the stem and the sleeve.

In at least one example embodiment, the sleeve is configured to engage the surface of the blind hole to form a fluid-tight seal.

In at least one example embodiment, the sleeve is configured to engage the body to form a fluid-tight seal at the interlock.

At least one example embodiment relates to a method of installing a plug in a blind hole.

In at least one example embodiment, the method includes inserting the plug at least partially within the blind hole. The plug includes a stem and a sleeve surrounding the stem. The stem includes a stem body and a stem head. The stem body defines a groove. The stem head includes a radial outer surface that is tapered outward in a first direction extending along a longitudinal axis and away from the stem body. The method further includes retaining the sleeve within the blind hole. The method further includes pulling the stem in a second direction opposite of the first direction to draw the stem head into the sleeve and thereby deform the sleeve such that a first portion of the sleeve is in the groove of the stem and a second portion of the sleeve directly engages a surface of the blind hole.

In at least one example embodiment, the pulling induces a radial compressive load in the sleeve.

In at least one example embodiment, engagement of the stem head with the sleeve causes the sleeve to deform radially outwardly so that the second portion of the sleeve directly engages the surface of the blind hole.

In at least one example embodiment, engagement of the stem head with the sleeve causes the sleeve to deform radially inwardly so that the first portion of the sleeve is in the groove.

In at least one example embodiment, during the inserting, the plug is in a pre-installed state in which the stem body engages the sleeve to retain the sleeve on the stem body.

In at least one example embodiment, the pulling causes a portion of the stem to separate from a remainder of the stem.

In at least one example embodiment, the remainder of the stem is entirely within an interior region of the sleeve.

In at least one example embodiment, the retaining includes engaging the sleeve with a tool.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an example of a sealing plug;

FIG. 2 is a side view of a stem of the sealing plug of FIG. 1;

FIG. 3 is a partial sectional view of the stem of FIG. 2 taken at line 3-3 of FIG. 2;

FIG. 4 is an enlarged portion of the stem of FIG. 3;

FIG. 5 is a sectional view of the stem of FIG. 2 taken at line 5-5 of FIG. 2;

FIG. 6 is a perspective view of a sleeve of the sealing plug of FIG. 1;

FIG. 7 is a sectional view of the sleeve of FIG. 6 taken at line 7-7 of FIG. 6;

FIG. 8 is a flowchart illustrating an example method of installing the sealing plug of FIG. 1 in a blind hole; and

FIGS. 9A-9E are schematic views that illustrate a method of sealing a blind hole using the example sealing plug of FIG. 1; FIG. 9A illustrates the sealing plug in a pre-installed state; FIG. 9B illustrates the sealing plug during a first time period of installation; FIG. 9C illustrates the sealing during a second time period of installation; FIG. 9D illustrates the sealing plug during a third time period of installation; and FIG. 9E illustrates the sealing plug in a fully installed or sealing state.

Corresponding reference numerals indicate corresponding parts throughout the several views of the drawings.

### DETAILED DESCRIPTION

Example embodiments will now be described more fully with reference to the accompanying drawings.

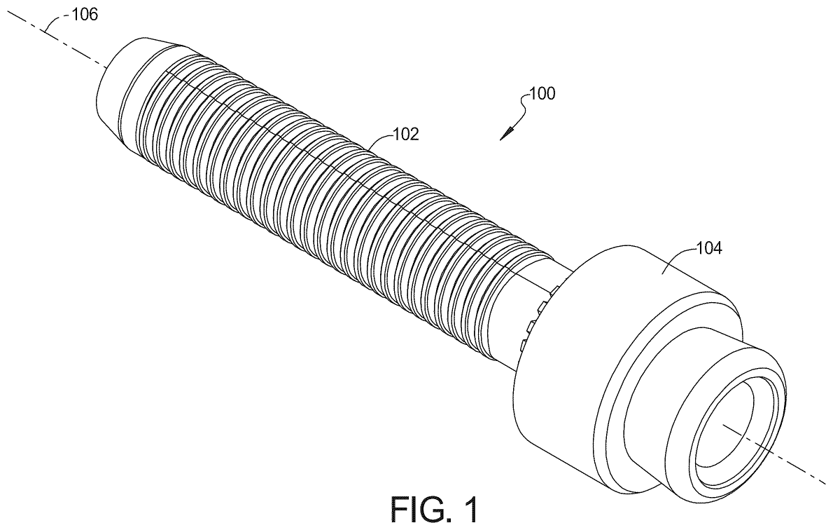

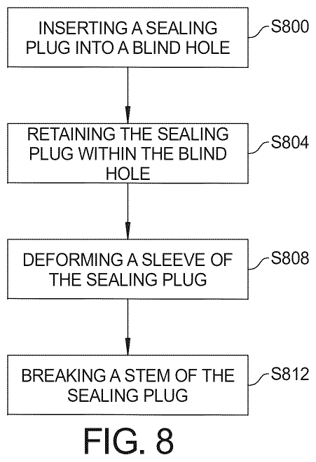

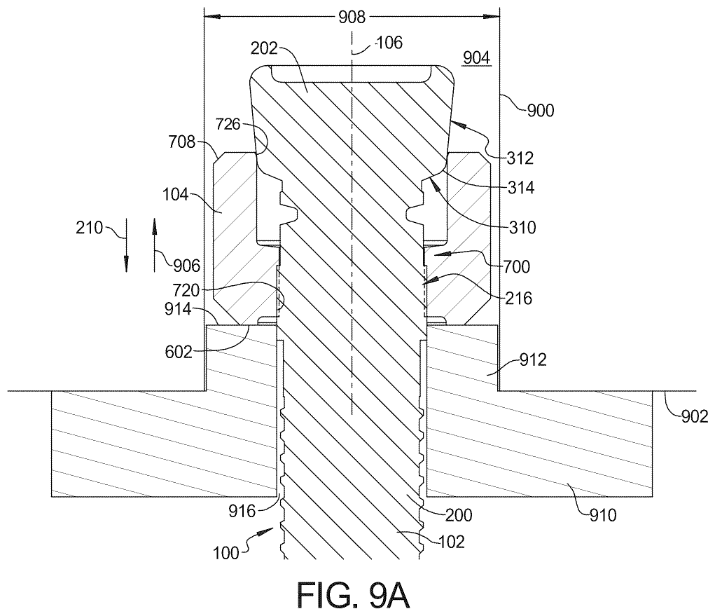

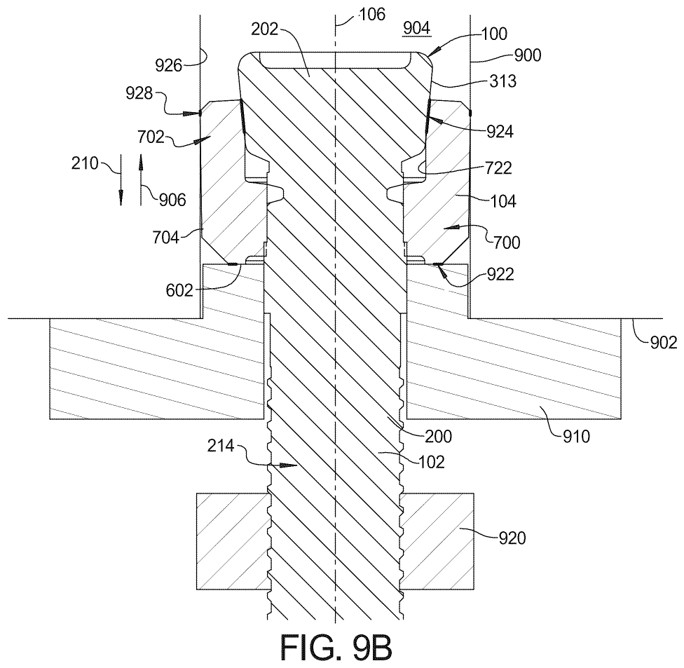

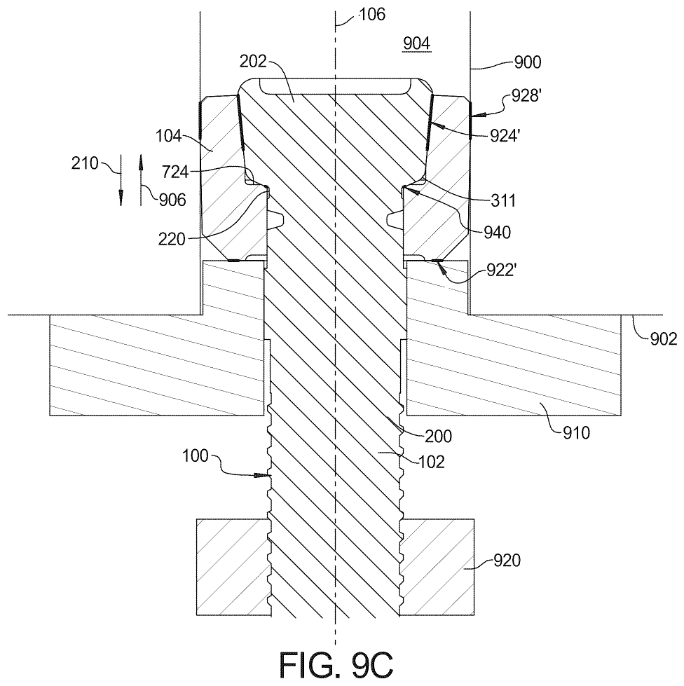

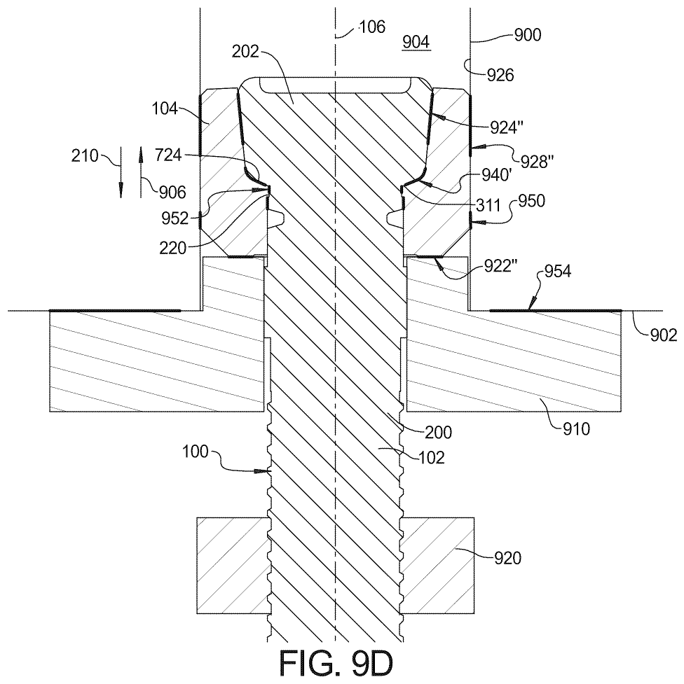

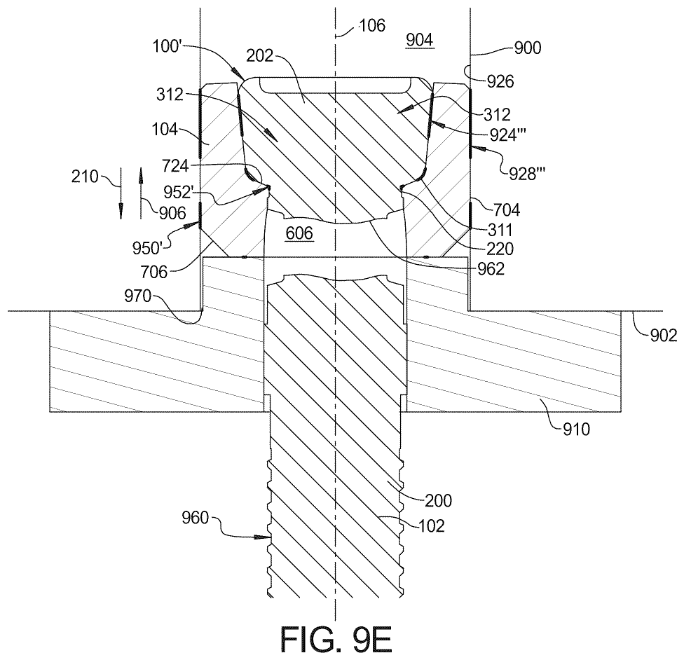

In at least one example embodiment, as shown in FIG. 1, a sealing plug 100 includes a stem 102 and a sleeve 104. The sleeve 104 is configured to at least partially surround the stem 102. When a portion of the stem 102 is within the sleeve 104, the stem 102 and sleeve 104 are aligned along a longitudinal axis 106 of the sealing plug 100. As will be described in greater detail below in the discussion accompanying FIGS. 8-9E, the sealing plug 100 is configured to be moved from a pre-installed state, as shown, to an installed state (shown in FIG. 9E) by translating the stem 102 along the longitudinal axis 106 with respect to the sleeve 104 while the sealing plug 100 is in a blind hole (see, e.g., application hole 904 in FIGS. 9A-9E).

In at least one example embodiment, the sealing plug 100 is an all-aluminum sealing plug such that both the stem 102 and the sleeve 104 are made from an aluminum alloy. For example, the stem 102 and the sleeve 104 may be made from aluminum grade 6061, 3103, 7075, or any combination thereof. The stem 102 and sleeve 104 may include the same or different aluminum alloy. In at least one other example embodiment, the stem 102 and/or the sleeve 104 may additionally or alternatively include another material, such as copper and/or brass.

The stem 102 has a first hardness that is greater than a second hardness of the sleeve 104. The sleeve 104 has a first ductility that is greater than a second ductility of the stem 102. In at least one example embodiment, the stem 102 has a Vickers hardness of about 100 and/or an ultimate tensile strength of about 300 MPa, and the sleeve 104 has a Vickers hardness of about 40 and/or an ultimate tensile strength of about 120 MPa. In at least one example embodiment, the sleeve 104 is made from one or more fully annealed aluminum alloys, while the stem 102 is made from one or more heat treated aluminum alloys. The sleeve 104 maintains some ductility to provide certain sealing benefits, such as those detailed below.

The aluminum construction of the sealing plug 100 may help to eliminate red rust that may be experienced, for example, when steel stems are used. Further, in at least one example embodiment, when an all-aluminum sealing plug is installed in, or used with, a typical aluminum casting (e.g., internal combustion engine block, gearbox, electrified vehicle motor), the all-aluminum sealing plug will have a similar thermal expansion rate as the application metal during various heating and cooling events, thereby reducing possible dimensional changes that might compromise the sealing performance of the sealing plug. Further still, in at least one example embodiment, using an aluminum stem may allow corrosion protective coatings, like electroplated zinc, to be omitted. Corrosion protective coatings often flake at a gripping point accumulating to clog equipment, eventually requiring disassembly and cleaning. Further still, in at least one example embodiment, all-aluminum sealing plugs may be lighter than sealing plugs including steel stems, helping to reduce wear and tear on equipment for inserting the all-aluminum sealing plugs, like tool pulling jaws and tool nose (e.g., nose tips). Further still, in at least one example embodiment, all-aluminum sealing plugs may be easier to cold form. In at least one example embodiment, all-aluminum sealing plugs may be readily recyclable.

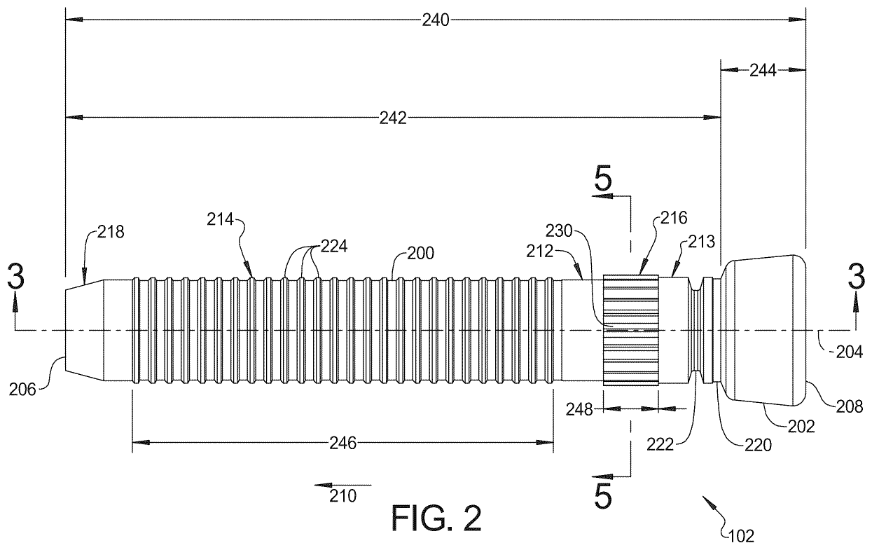

In at least one example embodiment, as shown in FIG. 2, the stem 102 includes a stem body 200 and a stem head 202. The stem 102 extends along a stem axis 204. The stem 102 may have rotational symmetry about the stem axis 204. When the stem 102 is coupled to the sleeve 104 (shown in FIG. 1), the stem axis 204 is aligned with the longitudinal axis 106.

The stem 102 extends between a first stem end 206 and a second stem end 208. The stem body 200 is at, adjacent to, or includes the first stem end 206. The stem head 202 is at, adjacent to, or includes the second stem end 208. The first stem end 206 is in a first direction 210 along the stem axis 204 with respect to the second stem end 208.

In at least one example embodiment, the stem body 200 includes a first main portion 212, a second main portion 213, a gripping portion 214, a textured portion 216, and a tapered portion 218. The first and second main portions 212, 213 may have a substantially smooth outer surface. The gripping portion 214 is disposed in the first direction 210 with respect to the textured portion 216. The tapered portion 218 is disposed in the first direction 210 with respect to the gripping portion 214. The tapered portion 218 includes the first stem end 206. The first main portion 212 is present on opposing longitudinal sides of the gripping portion 214. The second main portion 213 is present on opposing longitudinal sides of the breaker groove 222.

The stem body 200 defines a first groove or locking groove 220. The locking groove 220 may be defined in the second main portion 213 of the stem body 200, adjacent to the stem head 202. In at least one example embodiment, the locking groove 220 is directly adjacent to the stem head 202. As will be described in greater detail below, during installation, the locking groove 220 is configured to receive a portion of material of the sleeve 104 (shown in FIG. 1) to fix an axial position of the stem 102 within the sleeve 104, thereby reducing or preventing movement of the stem 102 with respect to the sleeve 104 along the longitudinal axis 106 (shown in FIG. 1) and effectively locking the stem 102 to the sleeve 104. The locking groove 220 may be described as an undercut, a recess, a receptacle, an internal lock, and/or an interlock feature.

In at least one example embodiment, the locking groove 220 is an annular groove. The locking groove 220 may extend around at least a portion of an outer diameter of the stem body 200. In the example embodiment shown, the locking groove 220 is an annular groove that extends around the entire circumference of the stem body 200. In at least one other example embodiment, the locking groove 220 extends around only a portion of circumference of the stem body 200 that is less than the entire circumference. In at least one example embodiment, the locking groove 220 includes a plurality of discrete locking grooves. The plurality of discrete locking grooves may be circumferentially spaced apart from one another about the stem axis 204. In at least one example embodiment, the locking groove 220 defines a trapezoidal cross sectional shape.

In at least one example embodiment, the stem body 200 further defines a second groove or breaker groove 222. The breaker groove 222 may be formed in the second main portion 213 of the stem body 200. The breaker groove 222 may be disposed in the first direction 210 along the stem axis 204 with respect to the locking groove 220. The locking groove 220 and breaker groove 222 may be adjacent to one another. The locking groove 220 and the breaker groove 222 may be spaced apart from one another along the stem axis 204 such that they are not directly adjacent to one another.

In at least one example embodiment, the breaker groove 222 is an annular groove. The breaker groove 222 may extend around at least a portion of an outer diameter of the stem body 200. In at least the example embodiment shown, the locking groove breaker extends around an entire circumference of the stem body 200. In at least one example embodiment, the breaker groove 222 has a trapezoidal cross section, as shown. However, a breaker groove may define other cross-sectional shapes, such as partially circular, rectangular, triangular, by way of example (not shown). In some example embodiments, a surface defining a breaker groove may have a C-shaped cross section (not shown)

In at least one example embodiment, the gripping portion 214 includes a plurality of annular grooves, ribs, threads or ridges 224. The annular ridges 224 may be spaced apart from one another along the stem axis 204. The annular ridges 224 may be substantially parallel to one another. The annular ridges 224 are configured to be engaged by a tool (see, e.g., pulling tool 920 in FIGS. 9B-9D) during installation of the sealing plug 100 (shown in FIG. 1) within a blind hole (see, e.g., application hole 904 in FIGS. 9A-9E). The gripping portion 214 may include different or additional features to facilitate gripping and pulling during installation.

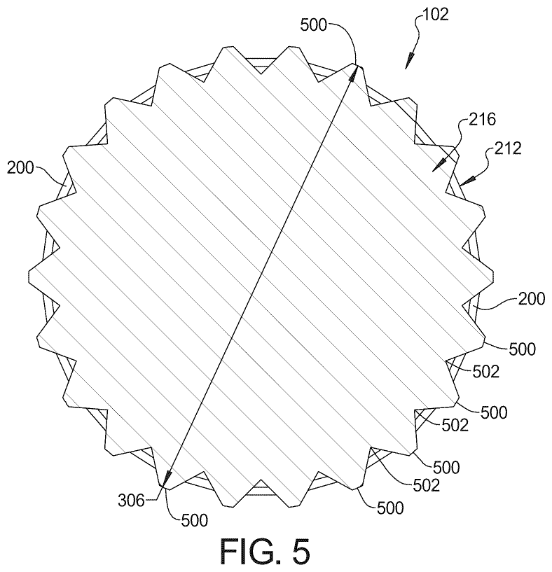

In at least one example embodiment, the textured portion 216 includes a plurality of axial splines 230, as shown. Additionally or alternatively, the textured portion 216 may include knurling. The textured portion 216 is configured to have an interference fit with a portion of the sleeve 104 (shown in FIG. 1) in a pre-installed state (shown in FIGS. 1 and 9A) to temporarily retain the stem 102 within the sleeve 104. In at least one example embodiment, the sealing plug 100 is placed in the pre-installed state by a manufacturer and is retained in the pre-installed state during shipping. The textured portion 216 is described in greater detail below in the discussion accompanying FIG. 5.

The stem 102 defines a total length 240 parallel to the stem axis 204. The stem body 200 defines a first length 242 parallel to the stem axis 204 and the stem head 202 defines a second length 244 parallel to the stem axis 204. The total length 240 may be a sum of the first and second lengths 242, 244. The first length 242 is greater than the second length 244. In at least one example embodiment, a ratio of the first length 242 to the second length 244 is greater than or equal to about 5 (e.g., greater than or equal to about 6, greater than or equal to about 7, greater than or equal to about 8, greater than or equal to about 9, greater than or equal to about 10, or greater than or equal to about 11). The ratio of the first length 242 to the second length 244 may be less than or equal to about 12 (e.g., less than or equal to about 11, less than or equal to about 10, less than or equal to about 9, less than or equal to about 8, less than or equal to about 7, or less than or equal to about 6).

The gripping portion 214 is present along a third length 246 of the stem body 200 parallel to the stem axis 204. The third length 246 may be greater than or equal to about 40% of the first length 242 of the stem body 200 (e.g., greater than or equal to about 45%, greater than or equal to about 50%, greater than or equal to about 55%, greater than or equal to about 60%, greater than or equal to about 65%, greater than or equal to about 70%, or greater than or equal to about 75%). The third length 246 may be less than or equal to about 80% of the stem body 200 (e.g., less than or equal to about 75%, less than or equal to about 70%, less than or equal to about 65%, less than or equal to about 60%, less than or equal to about 55%, less than or equal to about 50%, or less than or equal to about 45%).

The textured portion 216 is present along a fourth length 248 of the stem body 200 parallel to the stem axis 204. The fourth length 248 may be greater than or equal to about 5% of the first length 242 of the stem body 200 (e.g., greater than or equal to about 7.5%, greater than or equal to about 10%, greater than or equal to about 12.5%, greater than or equal to about 15%, greater than or equal to about 17.5%, greater than or equal to about 20%, or greater than or equal to about 22.5%). The fourth length 248 may be less than or equal to about 25% of the stem body 200 (e.g., less than or equal to about 22.5%, less than or equal to about 20%, less than or equal to about 17.5%, less than or equal to about 15%, less than or equal to about 12.5%, less than or equal to about 10%, or less than or equal to about 7.5%).

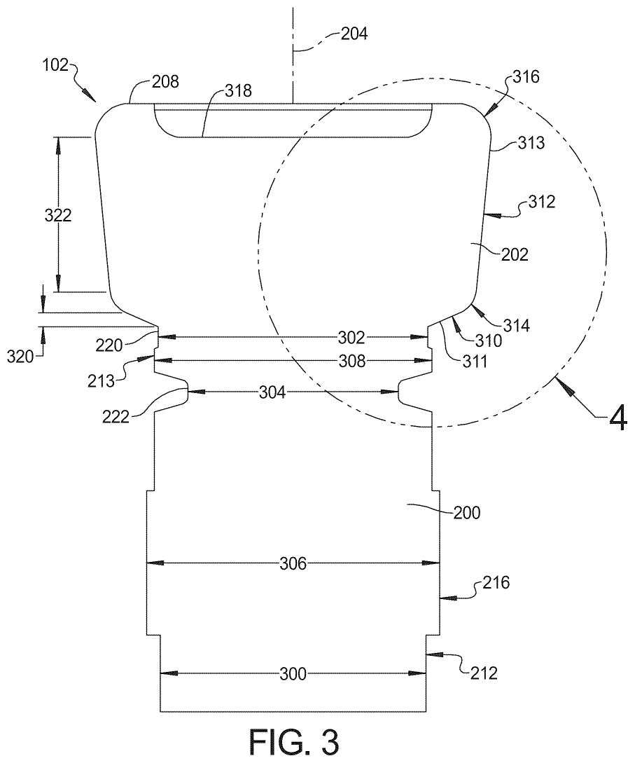

As shown in FIG. 3, the stem body 200 defines a first stem diameter or transverse dimension 300 at a longitudinal position of the first main portion 212. In at least one example embodiment, the stem body 200 has a constant outer diameter along a length of the first main portion 212. In other example embodiments, when there are variations in outer diameter along the length of the first main portion, the first stem diameter 300 may be an average diameter.

The stem body 200 defines a second stem diameter or transverse dimension 302 at an annular position of the locking groove 220. As shown in FIG. 3, the second stem diameter 302 may correspond to a smallest diameter of the locking groove 220. The stem body 200 defines a third stem diameter or transverse dimension 304 at a longitudinal position of the breaker groove 222. As shown in FIG. 3, the third stem diameter 304 may correspond to a smallest diameter of the breaker groove 222.

The stem body 200 defines a fourth stem diameter or transverse dimension 306 at a longitudinal position of the textured portion 216. The fourth stem diameter 306 is a largest diameter in the textured portion 216, as will be described in greater detail in the discussion accompanying FIG. 5. The fourth stem diameter 306 is greater than the first, second, and third stem diameters 300, 302, 304.

The stem body 200 defines a fifth stem diameter or transverse dimension 308 at a longitudinal position of the second main portion 213. The fifth stem diameter 308 of the second main portion 213 is greater than the second and third stem diameters 302, 304 of the locking groove 220 and the breaker groove 222, respectively. The fifth stem diameter 308 of the second main portion 213 may be less than the fourth stem diameter 306 of the textured portion 216. In at least one example embodiment, the fifth stem diameter 308 of the second main portion 213 is greater than the first stem diameter 300 of the first main portion 212. The second stem diameter 302 is less than the fifth stem diameter 308.

The second stem diameter 302 of the locking groove 220 is smaller than the fifth stem diameter 308 of the second main portion 213. Accordingly, a cross-sectional area of the stem body 200 perpendicular to the stem axis 204 at a location of the second stem diameter 302 is smaller than a cross-sectional area of the stem body 200 perpendicular to the stem axis 204 at a location of the fifth stem diameter 308 of the second main portion 213. The second stem diameter 302 of the locking groove 220 may be smaller than a diameter of the stem head 202 at a location that is directly adjacent the locking groove 220. The cross-sectional area of the stem body 200 at the location of the second stem diameter 302 may therefore be smaller than the cross-sectional area of the stem head 202 directly adjacent to the locking groove 220. In at least one example embodiment, the second stem diameter 302 of the locking groove 220 may also be less than any outer diameter of the stem head 202. The cross-sectional area of the stem body 200 at the location of the second stem diameter 302 may therefore be smaller than any cross-sectional area of the stem head 202 perpendicular to the stem axis 204. In this regard, the locking groove 220 may be described as a reduced cross-sectional area section. The differences in diameter and cross-sectional area between the locking groove 220 and adjacent portions of the stem 102 facilitate the formation of a lock between the stem 102 and material from the sleeve 104 (shown in FIG. 1) during installation, as will be described in greater detail below.

The third stem diameter 304 of the breaker groove 222 is less than the first, second, and fifth stem diameters 300, 302, 308 of the first main portion 212, locking groove 220, and second main portion 213, respectively. Accordingly, a cross-sectional area of the stem body 200 perpendicular to the stem axis 204 at a location of the third stem diameter 304 is smaller than a cross-sectional area of the stem body 200 perpendicular to the stem axis 204 at locations of the first stem diameter 300, the second stem diameter 302, and the fifth stem diameter 308.

In at least one example embodiment, a ratio of the second stem diameter 302 of the locking groove 220 to the third stem diameter 304 of the breaker groove 222 is greater than or equal to about 1.1 (e.g., greater than or equal to about 1.15, greater than or equal to about 1.2, greater than or equal to about 1.25, greater than or equal to about 1.3, or greater than or equal to about 1.35). The ratio of the second stem diameter 302 of the locking groove 220 to the third stem diameter 304 of the breaker groove 222 may be less than or equal to about 1.4 (e.g., less than or equal to about 1.35, less than or equal to about 1.3, less than or equal to about 1.25, less than or equal to about 1.2, or less than or equal to about 1.15).

The stem head 202 includes a first head portion 310 and a second head portion 312. The first head portion 310 includes a first head surface 311. The second head portion 312 includes a second head surface 313. The first head portion 310 is longitudinally between the second head portion 312 and the stem body 200. The first head portion 310 may be directly adjacent to the stem body 200. The first and second head surfaces 311, 313 may be referred to as radial outer surfaces. In the example shown, the first and second head surfaces 311, 313 are tapered outward in a direction along the stem axis 204 extending away from the stem body 200.

The stem head 202 may further include a first annular rounded portion 314 between the first and second head portions 310, 312, and a second annular rounded portion 316 between the second head portion 312 and the second stem end 208. The second stem end 208 may define a head recess 318. The head recess 318 may have a circular perimeter. In at least one example embodiment, the head recess 318 has a substantially uniform depth. A head recess 318 may have any other suitable shape. In at least one example embodiment, a head recess has a substantially conical shape (not shown).

The first head portion 310 defines a first head dimension 320 parallel to the stem axis 204. The second head portion 312 defines a second head dimension 322 parallel to the stem axis 204. In at least one example embodiment, the first head dimension 320 is less than the second head dimension 322. A ratio of the second head dimension 322 to the first head dimension 320 may be greater than or equal to about 5 (e.g., greater than or equal to about 6, greater than or equal to about 7, greater than or equal to about 8, greater than or equal to about 9, greater than or equal to about 10, greater than or equal to about 11, greater than or equal to about 12, greater than or equal to about 13, or greater than or equal to about 14). The ratio of the second head dimension 322 to the first head dimension 320 may be less than or equal to about 15 (e.g., less than or equal to about 14, less than or equal to about 13, less than or equal to about 12, less than or equal to about 11, less than or equal to about 10, less than or equal to about 9, less than or equal to about 8, less than or equal to about 7, or less than or equal to about 6).

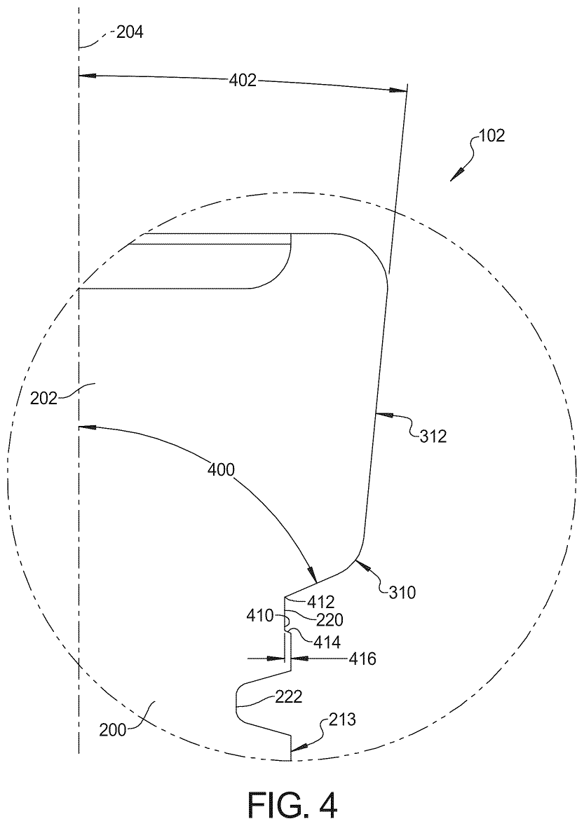

As shown in FIG. 4, the first head portion 310 of the stem head 202 defines a first angle 400 with respect to the stem axis 204. The first angle 400 is acute. The first angle 400 is greater than or equal to about 45°. In at least one example embodiment, the first angle 400 is greater than or equal to about 50° (e.g., greater than or equal to about 52.5°, greater than or equal to about 55°, greater than or equal to about 57.5°, greater than or equal to about 60°, greater than or equal to about 62.5°, greater than or equal to about 65°, greater than or equal to about 67.5°, greater than or equal to about 70°, greater than or equal to about 72.5°, greater than or equal to about 75°, or greater than or equal to about 77.5°). The first angle 400 may be less than or equal to about 80° (e.g., less than or equal to about 77.5°, less than or equal to about 75°, less than or equal to about 72.5°, less than or equal to about 70°, less than or equal to about 67.5°, less than or equal to about 65°, less than or equal to about 62.5°, less than or equal to about 60°, less than or equal to about 57.5°, less than or equal to about 55°, or less than or equal to about 52.5°).

The second head portion 312 of the stem head 202 defines a second angle 402 with respect to the stem axis 204. The second angle 402 is acute. The second angle 402 may be smaller than the first angle 400. The second angle 402 is less than or equal to about 45°. In at least one example embodiment, the second angle 402 is greater than or equal to about 4° (e.g., greater than or equal to about 4.25°, greater than or equal to about 4.5°, greater than or equal to about 4.75°, greater than or equal to about 5°, greater than or equal to about 5.25°, greater than or equal to about 5.5°, greater than or equal to about 5.75°, greater than or equal to about 6°, greater than or equal to about 6.25°, greater than or equal to about 6.5°, or greater than or equal to about 6.75°). The second angle 402 may be less than or equal to about 7° (e.g., less than or equal to about 6.75°, less than or equal to about 6.5°, less than or equal to about 6.25°, less than or equal to about 6°, less than or equal to about 5.75°, less than or equal to about 5.5°, less than or equal to about 5.25°, less than or equal to about 5°, less than or equal to about 4.75°, less than or equal to about 4.5°, or less than or equal to about 4.25°).

In at least one example embodiment, the locking groove 220 includes an inner groove surface 410, a first edge surface 412, and a second edge surface 414. An angle defined between the first edge surface 412 and the stem axis 204 may be the first angle 400. That is, the angle between the first edge surface 412 and the stem axis 204 may be the same as the same as the angle between the first head portion 310 and the stem axis 204. An angle between the second edge surface 414 and the longitudinal axis may be supplemental to the angle between the first edge surface 412 and the stem axis 204.

The locking groove 220 defines a depth 416 between an outer surface of the second main portion 213 of the stem body 200 and the inner groove surface 410. In at least one example embodiment, the depth 416 is greater than or equal to about 0.03 mm (e.g., greater than or equal to about 0.04 mm, greater than or equal to about 0.05 mm, greater than or equal to about 0.06 mm, greater than or equal to about 0.07 mm, greater than or equal to about 0.08 mm, greater than or equal to about 0.09 mm, greater than or equal to about 0.1 mm, greater than or equal to about 0.15 mm, greater than or equal to about 0.2 mm, or greater than or equal to about 0.25 mm). The depth 416 may be less than or equal to about 0.3 mm (e.g., less than or equal to about 0.25 mm, less than or equal to about 0.2 mm, less than or equal to about 0.15 mm, less than or equal to about 0.1 mm, less than or equal to about 0.09 mm, less than or equal to about 0.08 mm, less than or equal to about 0.07 mm, less than or equal to about 0.06 mm, less than or equal to about 0.05 mm, or less than or equal to about 0.04 mm).

In at least one example embodiment, as shown in FIG. 5, the textured portion 216 of the stem body 200 includes the plurality of axial splines 230. Each of the axial splines 230 includes a peak 500. A plurality of axial valleys 502 are defined between each of adjacent axial spline 230. The fourth stem diameter 306 is a largest diameter of the textured portion 216. In at least one example embodiment, the fourth stem diameter 306 is defined between two opposing peaks 500. As discussed above, a textured portion may additionally or alternatively include another texture, such as knurling.

In at least one example embodiment, the increased diameter (i.e., the fourth stem diameter 306) of the textured portion 216 compared to the first main portion 212 facilitates an interference fit between the stem body 200 and a portion of the sleeve 104 (shown in FIG. 1) in the pre-installed state, as will be discussed in greater detail below. In at least one example embodiment, a decreased surface area of the textured portion 216 compared to the first main portion 212, which may have a substantially smooth surface, may facilitate ease of assembly of the stem body 200 into the sleeve 104 due to a reduction of friction forces compared to a smooth surface.

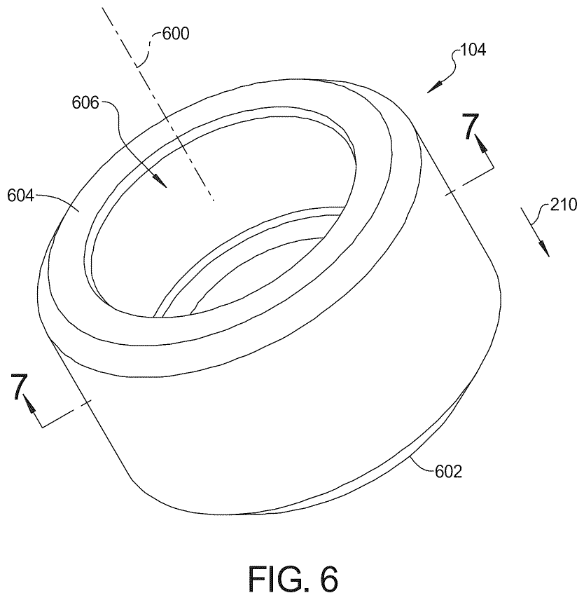

As shown in FIG. 6, the sleeve 104 extends along a sleeve axis 600. The sleeve 104 may have rotational symmetry about the sleeve axis 600. When the sleeve 104 is coupled to the stem 102 (shown in FIG. 1), the sleeve axis 600 is aligned with the longitudinal axis 106 and the stem axis 204 (shown in FIG. 2).

The sleeve 104 extends between a first sleeve end 602 and a second sleeve end 604. The first sleeve end 602 is in the first direction 210 with respect to the second sleeve end 604. The sleeve 104 defines an interior sleeve region 606. The interior sleeve region 606 is configured to receive at least a portion of the stem 102 (shown in FIG. 1). As will be described in greater detail in the discussion accompanying FIGS. 8-9E, the sleeve 104 is configured to deform during installation such that a portion of the sleeve 104 is displaced and/or flows into the locking groove 220 of the stem 102 (shown in FIG. 2).

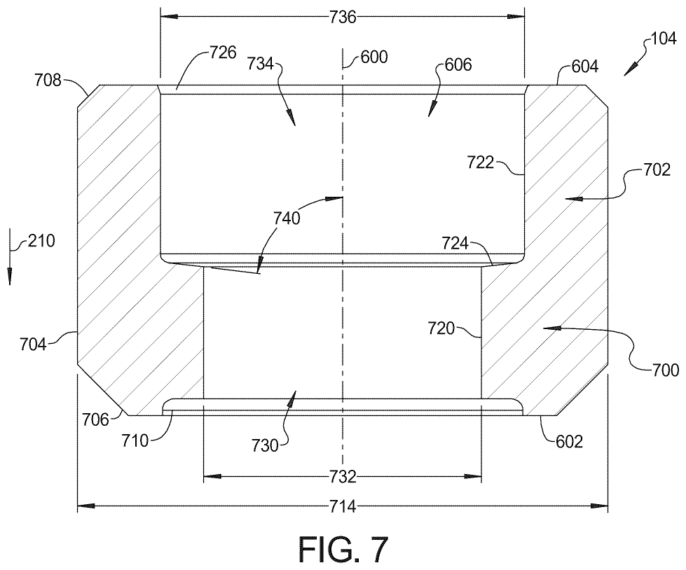

With reference to FIG. 7, the sleeve 104 includes a first sleeve portion 700 and a second sleeve portion 702. The first sleeve portion 700 is in the first direction 210 with respect to the second sleeve portion 702. The first sleeve portion 700 is at, adjacent to, and/or includes the first sleeve end 602. The second sleeve portion 702 is at, adjacent to, and/or includes the second sleeve end 604.

The sleeve 104 includes an annular outer surface 704. The sleeve 104 may further include a first chamfer 706 between the first sleeve end 602 and the annular outer surface 704, and a second chamfer 708 between the second sleeve end 604 and the annular outer surface 704. In some embodiments, a sleeve may exclude a first chamfer between a first sleeve end and an annular outer surface and/or a second chamfer between a second sleeve end and the annular outer surface (not shown). The first sleeve end 602 may define a sleeve recess 710. In some embodiments, a first sleeve end is free of a sleeve recess such that the first annular inner surface 720 extends to a first sleeve end (not shown). The annular outer surface 704 defines a sleeve outer diameter 714.

The first sleeve portion 700 includes a first annular inner surface 720. The second sleeve portion 702 includes a second annular inner surface 722. A step surface 724 is longitudinally between and connects the first and second annular inner surfaces 720, 722. A third chamfer 726 may be between the second sleeve end 604 and the second annular inner surface 722. In some embodiments, a sleeve may exclude a third chamfer between a second sleeve end and a second annular inner surface (not shown). A fourth chamfer may be between the step surface 724 and the first annular inner surface 720. In some embodiments, a sleeve is free of a fourth chamfer between a step surface and a first annular inner surface (not shown).

The first annular inner surface 720 of the first sleeve portion 700 defines a first bore 730 having a first bore diameter 732. The second annular inner surface 722 of the second sleeve portion 702 defines a second bore 734 defining a second bore diameter 736. The interior sleeve region 606 includes the first and second bores 730, 734.

The second bore diameter 736 is larger than the first bore diameter 732. In at least one example embodiment, a ratio of the second bore diameter 736 to the first bore diameter 732 is greater than or equal to about 1.1 (e.g., greater than or equal to about 1.2, greater than or equal to about 1.3, or greater than or equal to about 1.4). The ratio of the second bore diameter 736 to the first bore diameter 732 may be less than or equal to about 1.5 (e.g., less than or equal to about 1.4, less than or equal to about 1.3, or less than or equal to about 1.2).

In at least one example embodiment, the first bore diameter 732 is smaller than the fourth stem diameter 306 (shown in FIG. 3) to facilitate the interference fit between the textured portion 216 of the stem 102 (shown in FIG. 2) and the sleeve 104. In at least one example embodiment, a difference between the fourth stem diameter 306 of the textured portion 216 and the first bore diameter 732 is greater than or equal to about 0.15 mm (e.g., greater than or equal to about 0.175 mm, greater than or equal to about 0.2 mm, greater than or equal to about 0.225 mm, greater than or equal to about 0.25 mm, or greater than or equal to about 0.275 mm). The difference between the fourth stem diameter 306 and the first bore diameter 732 may be less than or equal to about 0.3 mm (e.g., less than or equal to about 0.275 mm, less than or equal to about 0.25 mm, less than or equal to about 0.225 mm, less than or equal to about 0.2 mm, or less than or equal to about 0.175 mm).

In at least one example embodiment, the first annular inner surface 720 is parallel to the sleeve axis 600. In at least one example embodiment, the second annular inner surface 722 is parallel to the sleeve axis 600. The step surface 724 defines a third angle 740 with respect to the sleeve axis 600.

In at least one example embodiment, the third angle 740 is acute. The third angle 740 is greater than or equal to about 45°. The third angle 740 may be larger than the first and second angles 400, 402 (shown in FIG. 4). In at least one example embodiment, the third angle 740 is greater than or equal to about 80° (e.g., greater than or equal to about 81°, greater than or equal to about 82°, greater than or equal to about 83°, greater than or equal to about 84°, or greater than or equal to about 85°). The third angle 740 may be less than or equal to about 86° (e.g., less than or equal to about 85°, less than or equal to about 84°, less than or equal to about 83°, less than or equal to about 82°, or less than or equal to about 81°).

FIG. 8 is a flowchart illustrating an example method of installing or placing a sealing plug in a blind hole or application hole. The method generally includes inserting a sealing plug in a pre-installed state into a blind hole of a workpiece at S800; retaining the sealing plug within the blind hole at S804; deforming a sleeve of the sealing plug such that a portion of the sleeve flows into a locking groove of a stem of the sealing plug at S808; and breaking off a portion of the stem at S812. Each of the above steps is described in greater detail below with reference to the sealing plug 100 of FIG. 1.

At S800, the method includes inserting a sealing plug into a blind hole or application hole of a workpiece. The workpiece may be an automotive component or assembly. Automotive components and assemblies may include an engine block, a gearbox, a transmission, an electric vehicle E-axle, a cooling system, or an oil gallery, by way of example.

As shown in FIG. 9A, a workpiece 900 includes an exposed surface 902 and a blind hole or application hole 904. As discussed above, the sealing plug 100 may be in a pre-installed state with the sleeve 104 retained on the stem 102 by engagement of the textured portion 216 of the stem 102 with the first annular inner surface 720 of the sleeve 104. Inserting the sealing plug 100 into the application hole 904 may include translating the sealing plug 100 in a second direction 906 opposite the first direction 210. In at least one example embodiment, the second chamfer 708 facilitates ease of insertion of sleeve 104 and the sealing plug 100 into the application hole 904.

The application hole 904 defines an application hole diameter 908. The sleeve 104 of the sealing plug 100 may have a clearance fit with respect to the application hole 904. Thus, an application hole diameter 908 may be greater than the sleeve outer diameter 714.

The sealing plug 100 is in a pre-installed state. In the pre-installed state, the textured portion 216 of the stem 102 engages the first annular inner surface 720 of the sleeve 104 in an interference fit. A portion of the sleeve engages the stem head 202. For example, the second head surface 313 and/or the second annular rounded portion 316 may directly engage the third chamfer 726.

At S804, the method includes retaining the sealing plug within the blind hole. Retaining the sealing plug 100 within the application hole 904 may include engaging the sleeve 104 of the sealing plug 100 with tool nose 910 (e.g., nose tips). The tool nose 910 may include a protrusion 912 that is inserted at least partially within the application hole 904. A tip surface 914 of the tool nose 910 may directly engage the first sleeve end 602. The tip surface 914 may be planar. When the tool nose 910 is inserted into the application hole 904 and engaging the sleeve 104 of the sealing plug 100 in the pre-installed state, the tip surface 914 is substantially perpendicular to the longitudinal axis 106 of the sealing plug 100.

The stem 102 of the sealing plug 100 extends through a cavity 916 of the tool nose 910. The stem 102 is spaced apart from an inner tool surface 918. Accordingly, the stem 102 can translate along the longitudinal axis 106 within the cavity 916 during installation of the sealing plug 100.

At S808, the method includes deforming a sleeve of the sealing plug. During deformation of the sleeve 104, the sealing plug 100 may transition through multiple partially installed states, including, but not limited to those shown in FIGS. 9B-9D. While FIGS. 9B-9D represent “snapshots,” it should be understood that the deformation may include more partially installed states than those shown. Moreover, the deformation may be continuous.

As will be described in greater detail below, the sleeve 104 is deformed primarily in a radial direction (i.e., perpendicular to the longitudinal axis 106) due to radially compressive loads during installation. For example, the sleeve 104 deforms radially outwardly to engage the workpiece 900 and radially inwardly to fill the locking groove 220 of the stem. Compared to other sealing plug designs that rely primarily upon axial compressive loads acting on a sleeve, the sealing plug 100 may facilitate use of a lower pulling force on the stem 102 and a more consistent flow of the material of the sleeve 104.

Deforming the sleeve 104 of the sealing plug 100 includes translating the stem 102 along the longitudinal axis 106 while retaining the sleeve 104 at predetermined axial location. The predetermined axial location is controlled, at least in part, based on size and shape of the tool nose 910. The stem 102 may be translated by engaging a pulling tool 920 (e.g., pulling jaws) with the gripping portion 214 of the stem body 200. As discussed above, the sleeve 104 is retained due to its axial engagement with the tool nose 910, as shown in a first contact region 922.

During a first time period of installation, as shown in FIG. 9B, the second head surface 313 directly engages the second annular inner surface 722 in the second contact region 924. Direct engagement between the second head surface 313 and the sleeve 104 creates a radially compressive load on the sleeve 104 and the forces a material of the sleeve 104 radially outwardly (i.e., away from the longitudinal axis 106). The displacement or flow of sleeve material causes a portion of the annular outer surface 704 of the sleeve 104 (e.g., at the second sleeve portion 702) to directly engage an application hole surface 926 in a third contact region 928.

Deformation of the sleeve 104 during the first period of time, as described above, may also cause the first sleeve end 602 to deform from being perpendicular to the longitudinal axis 106 to being angled. For example, a radially inner portion of the first sleeve end 602 may deform to be angled in the second direction 906, while a radially outer portion engages the tool nose 910 in the first contact region 922.

During a second time period of installation, as shown in FIG. 9C, the first head surface 311 engages the sleeve 104. For example, the first head surface 311 engages the step surface 724 in a fourth contact region 940. This engagement creates a radially compressive load that causes a portion of the material of the sleeve 104 to deform and flow radially inwardly into the locking groove 220.

During continued translation of the stem 102, the second contact region 924′ increases. This engagement increases the radially compressive load on the sleeve and causes the sleeve 104 to further deform and increase the third contact region 928′. The continued translation of the stem 102 may also increase the first contact region 922′.

During a third time period of installation, as shown in FIG. 9D, continued translation of the stem 102 causes increased contact between the first head surface 311 of the stem 102 and the step surface 724 of the sleeve 104 in the fourth contact region 940′. This increased contact increases the radial compressive load on the sleeve 104 and causes further deformation of the sleeve 104 to force more of the material of the sleeve 104 (e.g., in the first sleeve portion 700) radially outwardly into contact with the application hole surface 926, as shown in a fifth contact region 950.

Additionally, the increased radial compressive load forces additional material of the sleeve 104 to flow into the locking groove 220. The material of the sleeve 104 contacts a surface of the locking groove 220 (e.g., the inner groove surface 410, the first edge surface 412, and/or the second edge surface 414, shown in FIG. 4) in a sixth contact region 952. In at least one example embodiment, material of the sleeve 104 may fill the locking groove 220. In at least one example embodiment, the first angle 400 (shown in FIG. 4) of the stem head 202 may facilitate filling of the locking groove 220 with minimal deformation of the sleeve 104, for example, compared to a smaller first angle.

During continued translation of the stem 102, the second contact region 924″ increases. This engagement causes the sleeve 104 to further deform and increase the third contact region 928″. The continued translation of the stem 102 also further increases the first contact region 922″. The tool nose 910 may engage the exposed surface 902 of the workpiece 900 in a seventh contact region 954.

At S812, the method includes breaking a stem of the sealing plug. Breaking the stem 102 includes continued translation of the stem 102 along the longitudinal axis 106, as shown in FIG. 9E. The stem body 200 is configured to break at the breaker groove 222 (shown in FIG. 2) at a predetermined axial tensile load to remove a pintail 960 from the stem 102. At the time of break, a load from the pulling tool 920 (shown in FIGS. 9B-9D) is absent and axial loads from the tool are therefore absent from the sealing plug 100′ in the installed state. The tool nose 910 may be removed from the application hole 904.

The break may cause the stem body 200 to have a raw surface 962. Prior to breaking, the breaker groove 222 (shown in FIG. 2) is longitudinally disposed within the interior sleeve region 606 (e.g., the first bore 730, shown in FIG. 7). After breaking, the raw surface 962 is longitudinally disposed within the interior sleeve region 606. Placement of the raw surface 962 and remainder of the stem body 200 (i.e., the stem body 200 without the pintail 960) entirely within the interior sleeve region 606 may reduce or prevent external contact to the stem body 200, thereby reducing or minimizing chances of the stem head 202 being dislodged from installed sleeve 104 inside the application hole 904.

Due to positive radial pressure caused by deformation of the sleeve 104 and engagement of the sleeve 104 with the application hole surface 926 and the stem 102, the sealing plug 100′ is retained in the application hole 904 in a fluid-tight manner. The positive mechanical lock created by the above engagement facilitate the creation of a robust joint that can withstand cyclic pressure, temperature, and/or external forces to the workpiece 900.

In the fully installed state, a portion of the sleeve 104 is in the locking groove 220 of the stem 102. Engagement of the sleeve 104 with surface of the locking groove 220 may form a metal-to-metal, fluid-tight seal in the sixth contact region 952′. Engagement of the sleeve 104 with surface of the locking groove 220 reduces or prevents axial movement of the stem 102 with respect to the sleeve 104 in the first and second directions 210, 906. Thus, the material of the sleeve 104 in the locking groove 220 of the stem 102 creates an internal lock. Engagement of the first head surface 311 with the step surface 724 also reduces or prevents movement of the stem 102 with respect to the sleeve 104 in the first direction 210.

A metal-to-metal, fluid-tight seal is formed between the second head portion 312 and the sleeve 104 in the second contact region 924′″. A metal-to-metal fluid-tight seal is present between the application hole surface 926 and the annular outer surface 704 of the sleeve 104 in the third and fifth regions 928′″, 950′. In at least one example embodiment, a magnitude of the second angle 402 (shown in FIG. 4) of the second head portion 312 is selected such that, in the installed state, radial pressure is exerted by the sleeve 104 against the application hole surface 926.

A size of the first chamfer 706 may reduce or prevent material of the sleeve 104 from flowing into a space 970 defined between the tool nose 910 and the application hole surface 926. Accordingly, in the installed state, the sleeve 104 may be substantially free of sharp edges and/or burrs. In at least one example embodiment, a size of the first chamfer 706 may be reduced during installation.

The plugs 100, 100′ are referred to herein as sealing plugs or seal plugs because the plugs 100, 100′ are configured to create a fluid-tight seal in a blind hole (see, e.g., application hole 904 in FIGS. 9A-9E) such that fluid cannot flow through the blind hole past the plugs. However, the plugs 100, 100′ and other plugs according to the principles of the present application may be used in non-sealing applications such as securing parts like a blind rivet or to fill a hole without creating a fluid-tight seal therein.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected, or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A plug configured to be installed in a blind hole from one side thereof, the plug comprising:
a stem extending along a longitudinal axis, the stem including:
a stem body defining a first groove, and
a stem head including:
a radial outer surface that is tapered outward in a direction along the longitudinal axis extending away from the stem body; and
a sleeve configured to surround the stem and to deform radially inward during installation of the plug such that a portion of the sleeve is in the first groove when the plug is in an installed state.

2. The plug of claim 1, wherein the stem head includes a first portion defining a first angle with respect to the longitudinal axis, the first angle being acute.

3. The plug of claim 2, wherein the stem head includes:
the first portion, and
a second portion defining a second angle with respect to the longitudinal axis, the second angle being acute.

4. The plug of claim 3, wherein the first angle ranges from 65° to 69° and the second angle ranges from 5° to 6°.

5. The plug of claim 3, wherein
the first portion defines a first dimension parallel to the longitudinal axis,
the second portion defines a second dimension parallel to the longitudinal axis, and
a ratio of the second dimension to the first dimension is greater than or equal to about 5.

6. The plug of claim 1, wherein the first groove is an annular groove.

7. The plug of claim 1, wherein the first groove is directly adjacent to the stem head.

8. The plug of claim 1, wherein the sleeve includes:
a first annular inner surface defining a first bore having a first bore diameter,
a second annular inner surface defining a second bore having a second bore diameter larger than the first bore diameter, and
a step surface between the first annular inner surface and the second annular inner surface, the step surface configured to engage the stem head during installation of the plug.

9. The plug of claim 8, wherein the step surface defines a third angle with respect to the longitudinal axis, the third angle being acute.

10. The plug of claim 9, wherein the third angle ranges from 81°to 85°.

11. The plug of claim 8, wherein a ratio of the second bore diameter to the first bore diameter is greater than or equal to 1.2.

12. The plug of claim 1, wherein the stem body includes:
a main portion defining the first groove, and
a textured portion, the textured portion including knurling, splines, or both knurling and splines.

13. The plug of claim 1, wherein
the stem body defines a second groove, and
the stem body is configured to break at the second groove in response to an application of a predetermined tensile force to the stem parallel to the longitudinal axis.

14. The plug of claim 13, wherein the second groove is an annular groove.

15. The plug of claim 14, wherein,
the first groove defines a first transverse dimension,
the second groove defines a second transverse dimension, and
the second transverse dimension is less than the first transverse dimension.

16. The plug of claim 1, wherein
the plug is an all-aluminum plug, the stem and the sleeve each including an aluminum alloy,
the stem has a first hardness that is greater than a second hardness of the sleeve, and
the sleeve has a first ductility that is greater than a second ductility of the stem.

17. A plug configured to be installed in a blind hole from one side thereof, the plug comprising:
a stem extending along a longitudinal axis, the stem including:
a stem body defining a first annular groove, and
a stem head including:
a first portion defining a first angle with respect the longitudinal axis the, first angle being acute, and
a second portion defining a second angle with respect to the longitudinal axis, the second angle being smaller than the first angle; and
a sleeve configured to deform during installation of the plug such that a portion of the sleeve is in the first annular groove when the plug is in an installed state, the sleeve including:
a first annular inner surface defining a first bore having a first bore diameter,
a second annular inner surface defining a second bore having a second bore diameter larger than the first bore diameter, and
a step surface between the first annular inner surface and the second annular inner surface, the step surface configured to engage the stem head during installation of the plug, the step surface defining a third angle with respect to the longitudinal axis, the third angle being acute.

18. A plug configured to be installed in a blind hole from one side thereof, the plug comprising:
a sleeve defining an interior region; and
a stem including:
a body, and
a head, wherein:
in a pre-installed state, the body engages the sleeve to retain the sleeve on the stem,
during installation, the stem is configured to translate within the interior region of the sleeve such that the head engages the sleeve to deform a first portion of the sleeve radially outwardly to engage a surface of the blind hole, and to deform a second portion of the sleeve radially inwardly to engage the body, and
in an installed state, the second portion of the sleeve is at least partially in a receptacle of the body to form an interlock between the stem and the sleeve.

19. The plug of claim 18, wherein the sleeve is configured to engage the surface of the blind hole to form a fluid-tight seal.

20. The plug of claim 18, wherein the sleeve is configured to engage the body to form a fluid-tight seal at the interlock.
